(19) United States
(12) Patent Application Publication
(10) Pub. No.: US 2014/0019205 A1
(43) Pub. Date: Jan. 16, 2014

(54) IMPACT MEASUREMENT BASED ON DATA DISTRIBUTIONS

(71) Applicants: Stefan Kraus, Bruchsal (DE); Ruediger Eichin, Heidelberg (DE)

(72) Inventors: Stefan Kraus, Bruchsal (DE); Ruediger Eichin, Heidelberg (DE)

(73) Assignee: SAP AG, Walldorf (DE)

(21) Appl. No.: 13/546,157

(22) Filed: Jul. 11, 2012

(51) Int. Cl. G06Q 10/04; G06Q 30/02

(52) U.S. Cl. 705/7.31

(57) ABSTRACT

A system and method provide for performing impact analysis for influencing attributes in a sales forecasting system. The sales forecasting system uses integrated predictive and statistical methods to help measure the variance of relevant data sets to guide an end user to relevant influencing attributes. The sales forecasting system may perform a statistical analysis to derive a sequence for the influencing attributes, and display the attributes to an end user in a specific sequence based on the performed statistical analysis.

### BACKGROUND INFORMATION

Analytical applications are increasingly being based on very broad sets of data. This often occurs because most systems of records deliver improved process information along integrated process chains, which join together attributes from transactional and master data. Potentially, each of these joined attributes could be relevant to discover insights regarding success drivers or critical situations within the data. As result, an end user is confronted with a large list of attributes, which potentially could be of interest for further exploration, without an indication of which attributes are more relevant than others.

Different types of data can be combined together and used as a basis for analysis. This can result in a list of attributes, which potentially ranges between dozens to hundreds of attributes, depending on the amount of data being used. Without system support, it is very difficult for an end business user to select the best attributes for further analysis.

Thus, there remains a need in the art for a system that allows users to distinguish between useful attributes and attributes that may not be relevant to the user. There also remains a need in the art for a system to allow for the analysis of multidimensional data by measuring the potential impact of each attribute on business success, to allow an end user to make a more educated decision based on the presented attributes.

### SUMMARY

A system and method are described herein that provide for system and method provide for performing impact analysis for influencing attributes in a sales forecasting system. The sales forecasting system uses integrated predictive and statistical methods to help measure the variance of relevant data sets to guide an end user to relevant influencing attributes. The sales forecasting system may perform a statistical analysis to derive a sequence for the influencing attributes, and display the attributes to an end user in a specific sequence based on the performed statistical analysis.

In particular, the exemplary embodiments and/or exemplary methods are directed to a system and method for measuring an impact of various attributes based on data distributions of a sales forecasting system. The system and method include the step of determining a list of influencing attributes based on retrieved historical data that is retrieved from storage in an in-memory database and measuring a data distribution of each of the influencing attributes. The system and method also include the step of sorting the influencing attributes using a variance analysis, where a measure of variance is determined for each of the influencing attributes. In particular an analysis of variance statistical model can be used.

The system and method also include the step of ordering the influencing attributes in descending order based on the determined measure of variance for each of the influencing attributes, with influencing attributes having higher measures of variances determined to be most relevant. The influencing attributes can also be ordered in descending order based on a determined F-value.

The measure of variance and/or F-value can be determined as a function of a sum of squares of all opportunities and a sum of squares of opportunities of an individual influencing attribute. The sum of squares of opportunities of the specific influencing attribute can itself be determined as a function of attribute values of the individual influencing attribute. The measure of variance and/or F-value can also be determined as a function of the number of attribute values of the individual influencing attribute, a mean expected value of the individual influencing attribute, and a mean expected value of all opportunities.

The system and method also include the step generating a list of attribute values from a selected ordered influencing attribute. In this case, upon a user selection of at least one attribute value from the list of attribute values, at least one generated graphical display can be generated to compare the at least one attribute value to another selected attribute value. The at least one generated graphical display can illustrate a heterogeneity of the data distribution of the selected ordered influencing attribute.

The historical data, opportunity data, and the analysis of variance statistical model can all be stored in an in-memory database. Some of the influencing attributes can be calculated instantaneously when the historical data is retrieved from the in-memory database.

An advanced business application programming (ABAP) system can also be used to access the stored historical, opportunity data, and analysis of variance statistical model from the in-memory database if needed. The sales forecasting application can also be implemented on an integrated business platform.

### BRIEF DESCRIPTION OF THE DRAWINGS

FIG. 1 is a diagram of a sales forecasting application displayed on a user terminal according to an embodiment.

FIG. 2 is a diagram of the architecture of a sales forecasting system according to an embodiment.

FIG. 3 is a diagram of the impact analysis of various influencing attributes derived in the sales forecasting application as displayed on a user interface according to an embodiment.

### DETAILED DESCRIPTION

The subject matter will now be described in detail for specific preferred embodiments, it being understood that these embodiments are intended only as illustrative examples and is not to be limited thereto these embodiments.

Previous analytic applications were directed towards elaborated personalization and adaptation features that were ineffective in selecting the most pertinent attributes of sales orders and sales forecasting data. Embodiments provide a system and method for performing impact analysis for influencing attributes in a sales forecasting system. The sales forecasting system uses integrated predictive and statistical methods to help measure the variance of relevant data sets to guide an end user to relevant influencing attributes. The sales forecasting system may perform a statistical analysis to derive a sequence for the influencing attributes, and display the attributes to an end user in a specific sequence based on the performed statistical analysis.

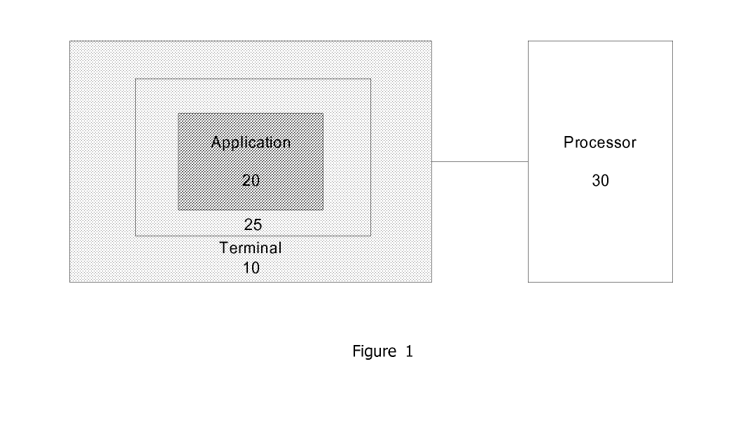

FIG. 1 illustrates a diagram of a user terminal 10 displaying a sales forecasting application 20 on the terminal. Application 20 may be executed, for example, by a processor 30 and may be displayed on a user interface 25 of user terminal 10 to a user. In an embodiment, application 20 may be provided on an integrated business platform and stored in a main memory database of a computing device. In an embodiment, the integrated business platform may be SAP Business ByDesign™. User terminal 10 may be embodied, for example, as a desktop, laptop, notebook, or other computing device. In other embodiments, user terminal 10 may be a hand-held device, personal digital assistant (PDA), television set-top Internet appliance, mobile telephone, smart phone, iPod™, iPhone™, iPad™, etc., or as a combination of one or more thereof, or other comparable device.

In an example embodiment, application 20 may be an application that is implemented on a back end component and displayed on a user interface on user terminal 10. In another embodiment, the application may be a computer-based application stored in the main memory database of user terminal 10.

In an example embodiment, the system and method may include one or more processors 30, which may be implemented using any conventional processing circuit and device or combination thereof, e.g., a central processing unit (CPU) of a personal computer (PC) or other workstation processor, to execute code provided, to perform any of the methods described herein, alone or in combination. In an embodiment, the executed code may be stored in a main memory database of user terminal 10. In this example embodiment, the main memory database may be an in-memory database such as SAP HANA™, where data is stored in the main memory (RAM).

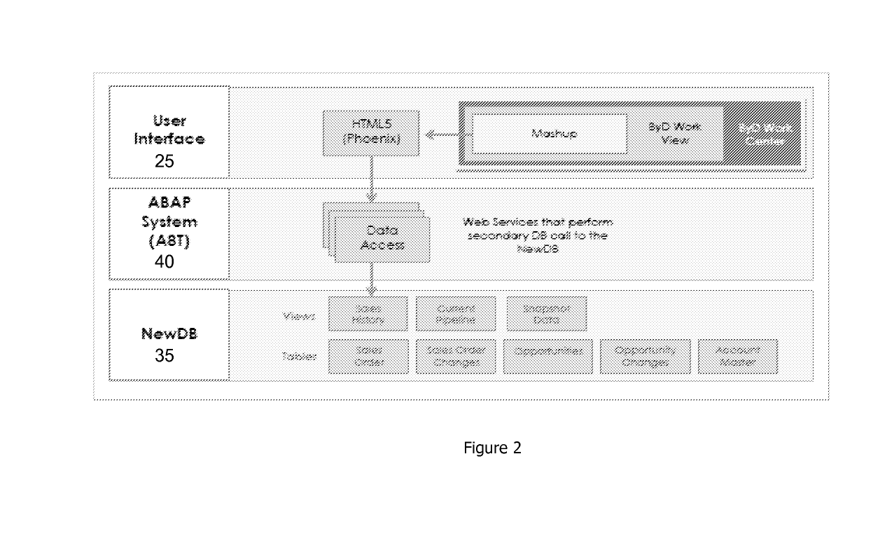

FIG. 2 illustrates a diagram of the architecture of the sales forecasting application and system according to an embodiment. In an embodiment, the sales forecasting system may be viewed on a user terminal 10 and communicate with a back end system. In the architecture depicted in FIG. 2, the sales forecasting system may include a database 35. In an embodiment, database 35 may be an in-memory database. Database 35 may be loaded with, and subsequently store, data such as customer data, sales orders, change data, opportunity data, and any master data. Data may be extracted from a plurality of productive systems and pushed into database 35. Examples of relevant data that may be stored in database 35 may include, as depicted in FIG. 2, “Sales Orders” “Sales Order Changes” “Opportunities”, “Opportunity Changes”, and “Account Master”. This data may be presented in tables, for example, to be retrieved from database 35. In an example embodiment, this data may be modeled through HANA modeling using HANA Studio™ and uploaded to database 35 via a file transfer.

Database 35 may also include data, for example, pertaining to “Sales History”, “Current Pipeline”, and “Snapshot Data”, which may provide data that may be viewed in a graphical manner by an end user. It should be understood that the examples of stored data as illustrated in FIG. 2 does not represent an exhaustive list of all data that may be stored in database 35.

In an embodiment, database 35 may also store a statistical method variance analysis (ANOVA) algorithm. The ANOVA algorithm may be applied as a stored procedure and may be used to join the various data.

The sales forecasting application 20 may be displayed on a user interface 25. User interface 25 may be designed specifically to provide an interaction flow to allow for combining the analytics on the retrieved data with visualizations derived from the retrieved data. In an embodiment, user interface 25 may be configured to display the integrated business platform such as SAP Business ByDesign™. The layout of the user interface 25 may be written in a plurality of programming languages. In an example embodiment, as illustrated in FIG. 2, an html language such as html5 may be used to design the user interface 25.

In an embodiment, data may be directly accessed from database 35 by the application. In another embodiment, the data from database 35 may be accessed using an advanced business application programming (ABAP) system 40. ABAP system 40 may be a web-based service defined in an internet communication frame work and may issue a secondary database call to database 35 to access the stored data. In an embodiment, ABAP system 40 may also retrieve the stored ANOVA model.

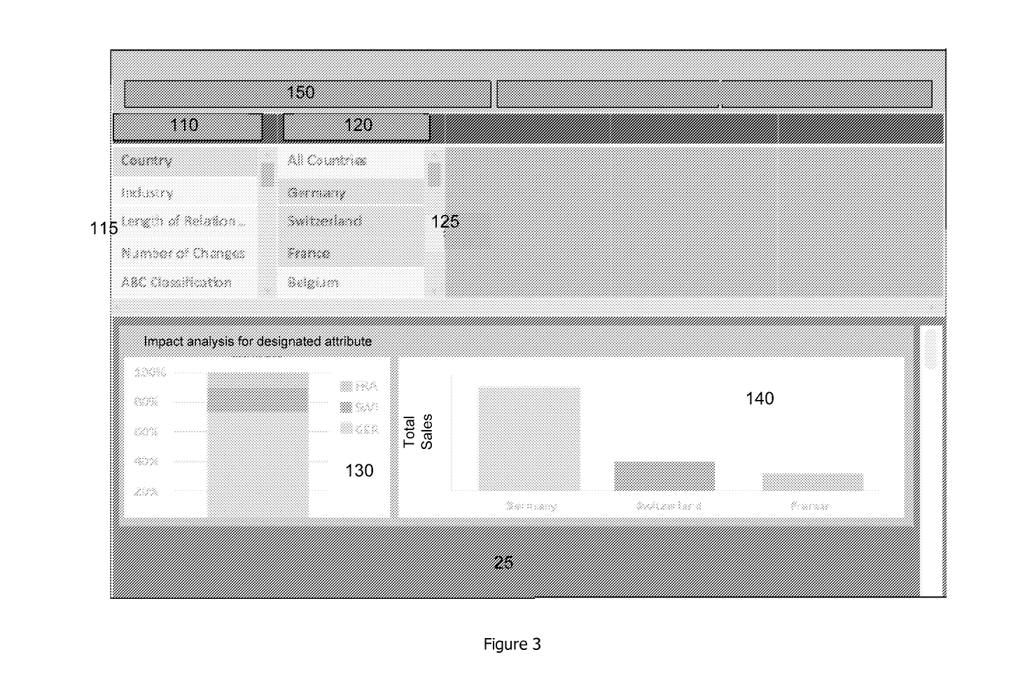

FIG. 3 illustrates a diagram of an impact analysis of various influencing attributes derived in the sales forecasting application as displayed on a user interface according to an embodiment. User interface 25 may display a viewing pane in which an analysis of the influencing attributes for historical sales orders may be displayed. In an embodiment, the viewing pane may be accessed by clicking from the pipeline analysis display. In another embodiment, the viewing pane may be accessed by opening a separate window from the current pipeline analysis display.

As illustrated in FIG. 3, the user interface 25 may display a list of influencing attributes for a specific time period. In input field 150, a user may select a period of the historical sales orders to analyze from a drop down menu. Panel 110 may display all of the influencing attributes for the period selected in input field 150. The system may provide a list of all influencing attributes after an analysis of the sales history for the designated period has been performed. These attributes may range from transactional and master data fields to fields which may be instantaneously calculated in-memory, such as the length of a relationship with a customer.

In order to focus on the most significant influencing attributes, the system may sort the attributes by relevance and display the attributes in selection field 115 based upon the sorting. In an example embodiment, the sort order, as well as the subsequent interactive analysis, may be driven by the assumption that a heterogeneous distribution of revenues across different groups, for example, different industries, is critical to differentiate between successful and unsuccessful business segments.

Sorting of the influencing attributes may be done by statistical methods that may be used to generate how the influencing attributes are presented to the end user. The statistical methods may also be used to guide the user through the numerous attributes in a time efficient manner. The highly relevant influencing attributes may be identified by measuring the data distribution, and thereby the heterogeneity of data. This may result in a sorted list of influencing attributes which may be displayed in selection field 115, with the most relevant influencing attributes on top. The sorting of the influencing attributes may be rooted in the assumption that heterogeneously distributed data is more relevant than homogenously distributed data.

In an embodiment, sales forecasting application 20 may use the ANOVA method for statistical analysis to measure the distribution of data. The stored ANOVA algorithm may be retrieved from database 35. A measure of heterogeneity may be derived using the ANOVA method to determine an F-value. Highly relevant influencing attributes may be identified by measuring the data distribution and categorized by a high F-Value. An F-value in the ANOVA statistical analysis may correspond to the ratio for the variance between items, here the influencing attributes, to the variance within items. This may be reflected in Equation (i):

$$F \text{-} value = \frac{Variance between attributes}{Variance within attributes} . \qquad ( i )$$

The ANOVA statistical method may be suited to systematically help the user to understand if the different groups show different contributions to success compared to the group as whole. The statistical application of the ANOVA method as direct towards the influencing attributes and future opportunity data may reflected in Table 1.

TABLE 1

| Parameter | Definition |
|---|---|
| y_{Industry =PSP}^{Opp =k} | Observed expected value for won Opportunity k in a |
| | specific Industry. |
| y̅_̅{̅I̅n̅d̅u̅s̅t̅r̅y̅}̅ | Mean expected value for a specific industry |
| y̅ | Mean expected value of all opportunities |
| k | Number of won and lost Opportunities in |
| | consideration |
| IND | Number of Industries |
| SS_{Total} = SS_{Between +} | Sum of Squares for all Opportunities and Groups by |
| SS_{Within} | Industry |

The notation reflected notation in Table 1 may correlate to an example embodiment, where the influencing attribute is based on the industry for the sales. In an alternate embodiment, where another influencing attribute is used, the ANOVA method may define the opportunities as a function of that specific influencing attribute.

As reflected in Table 1, each of the opportunities in the opportunity data may have an expected value. In an example embodiment where industry is an influencing attribute, a mean expected value may be determined for all opportunities and for the opportunities in a specific industry. In an alternate embodiment, where another influencing attribute is used, a mean expected value for all opportunities and for the opportunities in accordance with that influencing attribute may be listed.

In the example embodiment where the influencing attribute is the industry type, a sum of squares for all opportunity data by industry may be generated by Equation (ii). The sum of squares may be represented as the summation of the observed expected value for all won opportunities (previous opportunities that translated to sales previously) in a specific industry.

$${SS}_{Total} = {\sum }_{Industry = 1}^{IND} {\sum }_{k = 1}^{K} {( {y}_{Industry}^{Opp k} - \overline{y} )}^{2} . \qquad ( ii )$$

A sum of squares for all opportunity data between the various industries may be reflected by Equation (iii). The summation for opportunities between the various industries may be a function of the difference between the mean expected value for a specific industry and the mean expected value for all opportunities.

$${SS}_{between} = {\sum }_{Industry = 1}^{IND} {K ( \overline{{y}_{Industry}} - \overline{y} )}^{2} . \qquad ( iii )$$

A sum of squares for all opportunity data within each industry may be reflected by Equation (iv). The summation for opportunities within each industry may be a function of the difference between the mean expected value for a specific industry and the mean expected value for all opportunities.

$${SS}_{Within} = {\sum }_{Industry = 1}^{IND} {\sum }_{k = 1}^{K} {( {y}_{Industry}^{Opp k} - \overline{{y}_{Industry )}} )}^{2} . \qquad ( iv )$$

The measure for the actual variance may be determined by Equation (v). The variance may be reflected as a ratio between sum of squares for all opportunity data between the various industries taking into consideration the number of industries and the number of opportunities lost, and the sum of squares for all opportunity data within each industry taking into consideration the number of industries.

$$The measure for variation is = \frac{( {SS}_{between} + IND + ( K - 1 ) )}{{SS}_{within} * ( IND - 1 )} . \qquad ( v )$$

The measure of variation may be used to sort the influencing attributes accordingly in conjunction with Equation (i). The sort order may allow for an end user to focus on the most relevant influencing attributes, by creating a sorted list of influencing attributes, with the most relevant on top of the list. As illustrated, in FIG. 3, an end user may be presented with the most relevant attributes on top in selection field 115, and get the most appropriate visualization to understand the impact of each influencing factor on the success of previous sales. This also may provide an end user with system-support for a guided impact estimation, helping the user to understand the impact of each influencing attribute on the previous sales data, and allowing for the user to save their time when prioritizing their efforts to analyzing the drivers of success.

The evaluation of the underlying data distribution by the ANOVA method may also generate chart 130 and graph 140, which serve of a confirmation of the distribution impact analysis, by displaying results in both percentage and absolute values.

After the ANOVA method has generated the sorted list of the attributes for display in selection field 115, an end user may scroll through the list of influencing attributes via a scroll bar to view the entire contents of the list. As depicted in FIG. 3, examples of influencing attributes may include, but are not restricted to, “Country” (the country where customers who placed orders were located), “Industry” (pertaining to the specific industry in which the sale was made), “Length of Relationship” (how long a purchasing customer has been a customer), “Number of Changes”, and “ABC Classification”. A selection of an attribute from selection field 115 may generate a second panel 120. In panel 120, a user may select a attribute value in selection field 125. In an example embodiment, as depicted in FIG. 3, where a user selected “Country” from the list of influencing attributes, a list of countries from which sales occurred may be sorted and displayed in selection field 125.

In an alternate embodiment, the sorting of the attribute values of the selected influencing attribute may also be made by the ANOVA method. The ANOVA method may sort the attribute values of the selected attribute in accordance with Equations (i-v) to determine the measure of variance for the attribute values and determined which attribute value may have a highest F-value. The attributes in selection field 125 may be arranged in accordance with their relevance, with the attribute values have the highest F-value and determined to be the most relevant, arranged at the top of the selection field.

In selection field 125, a user may select to perform an analysis of one or more attribute values. This may occur through the selection of multiple attributes in selection field 125. A user may scroll through the list of attribute values in selection field 115 via a scroll bar and click on one or more attribute values. In the example embodiment depicted in FIG. 3, where a user selected “Country” from the list of influencing attributes, a user may select specific countries to compare or may select to compare all countries in which sales were made by selecting “All Countries”.

The selection of the attribute value(s) in selection field 125 may generate a number of figures which may provide for a comparison of the attribute values. A zebra chart may be displayed in panel 130. This zebra chart may graphically display a segmented comparison of the relative shares of each attribute value, as percentage, of success of the sales orders. In panel 140, a bar graph may be displayed comparing the attribute values. The bar graph in panel 140 may, for example, graphically display the absolute contribute that each of the further limiting attributes to total revenue. In another embodiment, a graphic display may be generated depicted the growth rate for each of the attribute values.

A user can interactively review the different influencing attributes and study the related distributions, statistical measures, and business trends provided by the generated figures.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for measuring an impact of various attributes based on data distributions of a sales forecasting system, the method comprising:
determining a list of influencing attributes based on retrieved historical data;
measuring a data distribution of each of the influencing attributes;
sorting the influencing attributes using a variance analysis, wherein a measure of variance is determined for each of the influencing attributes;
ordering the influencing attributes in descending order based on the determined measure of variance for each of the influencing attributes, the influencing attributes having higher measures of variances determined to be most relevant; and
displaying the ordered influencing attributes in a user interface of a user terminal.

2. The method according to claim 1, wherein the variance analysis is performed through an analysis of variance statistical model.

3. The method according to claim 1, wherein the influencing attributes are ordered in descending order based on a determined F-value for each of the influencing attributes, the influencing attributes having higher F-values determined to be most relevant.

4. The method according to claim 1, further comprising:
generating a list of attribute values from a selected ordered influencing attribute.

5. The method according to claim 1, wherein the measure of variance is determined as a function of a sum of squares of all opportunities and a sum of squares of opportunities of an individual influencing attribute.

6. The method according to claim 2, wherein the historical data and the analysis of variance statistical model are stored in an in-memory database.

7. The method according to claim 4, further comprising:
upon a user selection of at least one attribute value from the list of attribute values, displaying at least one generated graphical display comparing the at least one attribute value to another selected attribute value, the at least one generated graphical display illustrating a heterogeneity of the data distribution of the selected ordered influencing attribute.

8. The method according to claim 5, wherein the sum of squares of opportunities of the specific influencing attribute is a function of attribute values of the individual influencing attribute.

9. The method according to claim 5, wherein the measure of variance is determined as a function of a number of attribute values of the individual influencing attribute.

10. The method according to claim 5, wherein the measure of variance is determined as a function of a mean expected value of the individual influencing attribute.

11. The method according to claim 5, wherein the measure of variance is determined as a function of a mean expected value of all opportunities.

12. The method according to claim 6, wherein some of the influencing attributes are calculated instantaneously when the historical data is retrieved from the in-memory database.

13. A forecasting system for measuring an impact of various attributes based on data distributions, the system comprising:
at least one user terminal displaying a user interface, the sales forecasting system displayed on the user interface;
an in-memory database storing historical data and opportunity data; and
a processor operable to:
retrieve the historical data from the in-memory database;
determine a list of influencing attributes based on the retrieved historical data;
measure a data distribution of each of the influencing attributes;
sort the influencing attributes using a variance analysis, wherein a measure of variance is determined for each of the influencing attributes;
order the influencing attributes in descending order based on the determined measure of variance for each of the influencing attributes, the influencing attributes having higher measures of variances determined to be most relevant; and
display the ordered influencing attributes in the user interface of the user terminal.

14. The system according to claim 13, further comprising:
an advanced business application programming (ABAP) system to access the stored historical and opportunity data from the in-memory database.

15. The system according to claim 13, wherein the sales forecasting system is implemented on an integrated business platform.

16. The system according to claim 13, wherein the variance analysis is performed through an analysis of variance statistical model that is stored in the in-memory database.

17. The system according to claim 13, wherein the influencing attributes are ordered in descending order based on a determined F-value for each of the influencing attributes, the influencing attributes having higher F-values determined to be most relevant.

18. The system according to claim 13, wherein the measure of variance is determined as a function of at least one of: a) a sum of squares of all opportunities, b) a sum of squares of opportunities of an individual influencing attribute, c) attribute values of the individual influencing attribute, d) a number of attribute values of the individual influencing attribute, e) a mean expected value of the individual influencing attribute, and f) a mean expected value of all opportunities.

19. A forecasting system for measuring an impact of various attributes based on data distributions, the system comprising:
at least one user terminal;
an in-memory database storing historical data, opportunity data, and an analysis of variance statistical model;
an advanced business application programming (ABAP) system to access the stored historical and opportunity data from the in-memory database, the ABAP system also accessing the analysis of variance statistical model from the in-memory database;
an application displayed on a user interface of the user terminal, the application configured to:
determine a list of influencing attributes based on the retrieved historical data;
measure a data distribution of each of the influencing attributes;
sort the influencing attributes using a variance analysis, wherein a measure of variance is determined for each of the influencing attributes;
order the influencing attributes in descending order based on the determined measure of variance for each of the influencing attributes, the influencing attributes having higher measures of variances determined to be most relevant; and
display the ordered influencing attributes in the user interface of the user terminal.

20. A method for measuring an impact of various attributes based on data distributions of a sales forecasting system, the method comprising:
determining a list of influencing attributes based on retrieved historical data;
measuring a data distribution of each of the influencing attributes;
sorting the influencing attributes using an analysis of variance statistical model retrieved from an in-memory database, wherein a F-value and a measure of variance are determined for each of the influencing attributes;
ordering the influencing attributes in descending order based on the determined F-value and measure of variance for each of the influencing attributes, the influencing attributes having higher F-values and measures of variances determined to be most relevant; and
displaying the ordered influencing attributes in a user interface of a user terminal;
wherein the F-value and the measure of variance are determined as a function of a sum of squares of all opportunities and a sum of squares of opportunities of an individual influencing attribute, the F-value and the measure of variance also being a function of at least one of: a) a function of a number of attribute values of the individual influencing attribute, b) a mean expected value of the individual influencing attribute, and c) a mean expected value of all opportunities.
